(19) United States
(12) Patent Application Publication
(10) Pub. No.: US 2008/0146708 A1
(43) Pub. Date: Jun. 19, 2008

(54) Salts of asymmetrically substituted bis (1-hydroxymethyl)phosphinic acids

(75) Inventors: Harald Bauer, Kerpen (DE); Werner Krause, Huerth (DE); Wiebke Maas, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/002,136

(22) Filed: Dec. 14, 2007

(30) Foreign Application Priority Data
Dec. 18, 2006 (DE) 10 2006 059 720.6

(51) Int. Cl. C08K 5/51; C07F 9/30

(52) U.S. Cl. 524/147; 562/23

(57) ABSTRACT

The invention relates to salts of asymmetrically substituted bis(1-hydroxymethyl)phosphinic acids, of the formula (I)

A-P(═O)(OX)—B (I)

in which

A is R₁R₂C(OH)— and B is R₃R₄C(OH)—, with the proviso that the respective groups R₁R₂C(OH)— and —C(OH)R₃R₄ are always different, and where R₁, R₂, R₃, and R₄ are hydrogen, alkyl, alkenyl, alkynyl, aralkyl, aryl and/or substituted aryl, and

X is an element of the first main group, an element of the second main or transition group, an element of the third main or transition group, an element of the fourth main or transition group, an element of the eighth transition group and/or

a nitrogen base.

The present invention is described in the German priority application No. 10 2006 059 720.6, filed Dec. 18, 2006, which is hereby incorporated by reference as is fully disclosed herein.

The invention relates to salts of asymmetrically substituted bis(1-hydroxymethyl)phosphinic acids, to a process for their preparation, and to their use.

In the available prior art, salts of asymmetrically substituted bis(1-hydroxymethyl)phosphinic acids, such as those of the formula (I)

A-P(═O)(OX)—B (I)

are difficult or impossible to obtain.

A disadvantage of the processes known hitherto is variable yield losses. Furthermore, it has not hitherto been possible to prepare asymmetrically substituted salts of bis(1-hydroxymethyl)phosphinic acids reproducibly in a targeted manner, and with defined substituents and, respectively, carbon-chain lengths, and with selected cations. Many compounds from this group have been hitherto unobtainable.

It is therefore an object of the present invention to provide salts of asymmetrically substituted bis(1-hydroxymethyl)phosphinic acids. The object is achieved via representatives of this group of substance which bear selected organic substituents in 1- and 1′-position, and which contain appropriate, inventively selected cations.

The invention therefore provides salts of asymmetrically substituted bis(1-hydroxymethyl)phosphinic acids, of the formula (I)

A-P(═O)(OX)—B (I)

in which
A is R₁R₂C(OH)— and B is R₃R₄C(OH)—, with the proviso that the respective groups R₁R₂C(OH)— and —C(OH)R₃R₄ are always different, and where
R₁, R₂, R₃, and R₄ are hydrogen, alkyl, alkenyl, alkynyl, aralkyl, aryl and/or substituted aryl, and
X is an element of the first main group, an element of the second main or transition group, an element of the third main or transition group, an element of the fourth main or transition group, an element of the eighth transition group and/or
a nitrogen base.

It is preferable that R₁, R₂, R₃, and/or R₄ bear heteroatoms, and/or have substitution by a functional group.

It is preferable that the functional groups are carbonyl, aldehyde, carboxy, hydroxy, sulfonic acid, nitrile, cyano, and/or epoxy groups; primary, secondary, and/or tertiary amino groups, and/or unsubstituted, partially substituted, or fully substituted triazines.

It is preferable that the alkyl groups are methyl, ethyl, n-propyl, i-propyl, n-butyl, sec-butyl, tert-butyl, n-octyl and/or ethylhexyl.

It is preferable that the carboxy groups are carboxyalkyl groups of (CH₂)ₙCO₂H type, where n=from 1 to 6.

It is preferable that the hydroxy groups are hydroxyalkyl groups of (CH₂)ₙOH type, where n=from 1 to 6.

It is preferable that X is Li, Na, K; Mg, Ca, Zn; Al, Ce, La; Sn, Pb, Ti, Zr; Fe; NH₄, NH₃R₁, NH₂R₁R₂, NHR₁R₂R₃ or NR₁R₂R₃R₄.

Another object of the present invention is to provide a process for the preparation of asymmetrically substituted bis(1-hydroxymethyl)phosphinic acids, of the formula (I).

This object is achieved via reaction of an appropriate phosphinic acid in a solvent system with a salt which contains the desired cation and which contains anions identical with those formed via autodissociation in the solvent system.

The invention therefore also provides a process for the preparation of salts of asymmetricalily substituted bis(1-hydroxymethyl)phosphinic acids, of the formula (I), which comprises reacting an asymmetrically substituted phosphinic acid in a solvent system with a reactant A, where the reactant A is an element or a salt of an element of the first main group, an element or a salt of an element of the second main or transition group, an element or a salt of an element of the third main or transition group, an element or a salt of an element of the fourth main or transition group, an element or a salt of an element of the eighth transition group, and/or a nitrogen base.

The invention also provides the use of the inventive salts of the asymmetrically substituted bis(1-hydroxymethyl)phosphinic acids in flame retardants, since the inventive salts of asymmetrically substituted phosphinic acids have flame-retardant activity at substantially lower temperatures than the representatives of the prior art.

The invention therefore also provides the use of salts of the asymmetrically substituted bis(1-hydroxymethyl)phosphinic acids, as claimed in one or more of claims 1 to 7, as flame retardants, in particular in clear lacquers and intumescent coatings, as flame retardants for wood and other cellulose-containing products, as reactive and/or non/reactive flame retardant for polymers, for the preparation of flame-retardant polymer molding compositions, for the preparation of flame-retardant polymer moldings, for providing flame retardancy to polyester and to unblended or blended cellulose textiles via impregnation; as binders, e.g. for foundry materials, molding sands; as crosslinking agents, or as accelerators in the hardening of epoxy resins, of polyurethanes, or of unsaturated polyester resins; as light stabilizer and/or heat stabilizer for cotton textiles, polymer fibers, and plastics; as plant-protection agent, e.g. as plant-growth regulator; as herbicide, pesticide, or fungicide; as therapeutic agent or additive in therapeutic agents for humans and animals, e.g. as enzyme modulator or for stimulation of tissue growth; as sequestering agent, e.g. for the control of deposits in industrial water supply systems; in petroleum production and in metal-treatment agents; as petroleum additive, e.g. as antioxidant and for increasing octane number; as corrosion-protection agent; in laundry-detergent and cleaning-product applications, e.g. as decolorizer; in electronics applications e.g. in polyelectrolytes for capacitors, batteries, and accumulators; as free-radical scavenger in photosensitive layers; as aldehyde scavenger, e.g. formaldehyde or acetaldehyde scavenger.

The invention likewise relates to a flame-retardant thermoplastic polymer molding composition comprising from 0.5 to 45% by weight of salts of asymmetrically substituted bis(1-hydroxymethyl)phosphinic acids, as claimed in at least one of claims 1 to 7, and from 0.5 to 99.5% by weight of thermoplastic polymer or a mixture of these, where the entirety of the components is 100% by weight.

It also provides a flame-retardant thermoset polymer molding composition, comprising from 0.1 to 45% by weight of salts of asymmetrically substituted bis(1-hydroxymethyl)phosphinic acids, as claimed in at least one of claims 1 to 7, from 40 to 89.9% by weight of unsaturated polyesters, and from 10 to 60% by weight of vinyl monomer.

Finally, the invention also provides a flame-retardant epoxy resin, comprising from 0.5 to 50% by weight of salts of asymmetrically substituted bis(1-hydroxymethyl)phosphinic acids, as claimed in at least one of claims 1 to 7,

from 5 to 99.5% by weight of an epoxy resin, and from 0 to 20% by weight of a hardener.

Other preferred substituents for R₁, R₂, R₃, and R₄ in formula (I) are substituted phenyl, preferably mono-, bis-, and/or tri-substituted hydroxyphenyl, aminophenyl, N-alkylaminophenyl, or N,N-dialkylaminophenyl.

Among inventive compounds are the following salts of asymmetrically substituted phosphinic acids:

(H)(H)C(OH)—P(═O)(ONa)—C(OH)(H)(methyl), (H)(H)C(OH)—P(═O)(OK)—C(OH)(H)(phenyl), (H)(H)C(OH)—P(═O)(ONH₄)—C(OH)(H)((CH₂)₂CO₂H), (H)(H)C(OH)—P(═O)(ONa)—C(OH)(methyl)(methyl), (H)(H)C(OH)—P(═O)(OK)—C(OH)(phenyl)(methyl), (H)(H)C(OH)—P(═O)(ONH₄)—C(OH)((CH₂)₂CO₂H)(methyl), (H)(H)C(OH)—P(═O)(ONa)—C(OH)(phenyl)(phenyl), (H)(H)C(OH)—P(═O)(OK)—C(OH)(phenyl)((CH₂)₂CO₂H), (H)(H)C(OH)—P(═O)(ONH₄)—C(OH)((CH₂)₂CO₂H)((CH₂)₂CO₂H), (H)(phenyl)C(OH)—P(═O)(ONa)—C(OH)(H)(methyl), (H)((CH₂)₂CO₂H)C(OH)—P(═O)(OK)—C(OH)(H)(methyl), (H)(methyl)C(OH)—P(═O)(ONH₄)—C(OH)(H)(phenyl), (H)(methyl)C(OH)—P(═O)(ONa)—C(OH)(H)((CH₂)₂CO₂H), (H)(phenyl)C(OH)—P(═O)(OK)—C(OH)(H)((CH₂)₂CO₂H), (H)(H)C(OH)—P(═O)(ONH₄)—C(OH)(methyl)(methyl), (H)(methyl)C(OH)—P(═O)(ONa)—C(OH)(methyl)(methyl), (H)(phenyl)C(OH)—P(═O)(OK)—C(OH)(methyl)(methyl), (H)((CH₂)₂CO₂H)C(OH)—P(═O)(ONH₄)—C(OH)(methyl)(methyl), (H)(H)C(OH)—P(═O)(ONa)—C(OH)(phenyl)(methyl), (H)(methyl)C(OH)—P(═O)(OK)—C(OH)(phenyl)(methyl), (H)(phenyl)C(OH)—P(═O)(ONH₄)—C(OH)(phenyl)(methyl), (H)((CH₂)₂CO₂H)C(OH)—P(═O)(ONa)—C(OH)(phenyl)(methyl), (H)(H)C(OH)—P(═O)(OK)—C(OH)((CH₂)₂CO₂H)(methyl), (H)(methyl)C(OH)—P(═O)(ONH₄)—C(OH)((CH₂)₂CO₂H)(methyl), (H)(phenyl)C(OH)—P(═O)(ONa)—C(OH)((CH₂)₂CO₂H)(methyl), (H)((CH₂)₂CO₂H)C(OH)—P(═O)(OK)—C(OH)((CH₂)₂CO₂H)(methyl), (H)(H)C(OH)—P(═O)(ONH₄)—C(OH)(phenyl)(phenyl), (H)(methyl)C(OH)—P(═O)(ONa)—C(OH)(phenyl)(phenyl), (H)(phenyl)C(OH)—P(═O)(OK)—C(OH)(phenyl)(phenyl), (H)((CH₂)₂CO₂H)C(OH)—P(═O)(ONH₄)—C(OH)(phenyl)(phenyl), (H)(H)C(OH)—P(═O)(ONa)—C(OH)(phenyl)((CH₂)₂CO₂H), (H)(methyl)C(OH)—P(═O)(OK)—C(OH)(phenyl)((CH₂)₂CO₂H), (H)(phenyl)C(OH)—P(═O)(ONH₄)—C(OH)(phenyl)((CH₂)₂CO₂H), (H)((CH₂)₂CO₂H)C(OH)—P(═O)(ONa)—C(OH)(phenyl)((CH₂)₂CO₂H), (H)(H)C(OH)—P(═O)(OK)—C(OH)((CH₂)₂CO₂H)((CH₂)₂CO₂H), (H)(methyl)C(OH)—P(═O)(ONH₄)—C(OH)((CH₂)₂CO₂H)((CH₂)₂CO₂H), (H)(phenyl)C(OH)—P(═O)(ONa)—C(OH)((CH₂)₂CO₂H)((CH₂)₂CO₂H), (H)((CH₂)₂CO₂H)C(OH)—P(═O)(OK)—C(OH)((CH₂)₂CO₂H)((CH₂)₂CO₂H), (phenyl)(methyl)C(OH)—P(═O)(ONH₄)—C(OH)(methyl)(methyl), ((CH₂)₂CO₂H)(methyl)C(OH)—P(═O)(ONa)—C(OH)(methyl)(methyl), (methyl)(phenyl)C(OH)—P(═O)(OK)—C(OH)(methyl)(methyl), (phenyl)(phenyl)C(OH)—P(═O)(ONH₄)—C(OH)(methyl)(methyl), ((CH₂)₂CO₂H)(phenyl)C(OH)—P(═O)(ONa)—C(OH)(methyl)(methyl), (methyl)((CH₂)₂CO₂H)C(OH)—P(═O)(OK)—C(OH)(methyl)(methyl), (phenyl)((CH₂)₂CO₂H)C(OH)—P(═O)(ONH₄)—C(OH)(methyl)(methyl), ((CH₂)₂CO₂H)((CH₂)₂CO₂H)C(OH)—P(═O)(ONa)—C(OH)(methyl)(methyl), (methyl)(H)C(OH)—P(═O)(OK)—C(OH)(phenyl)(methyl), (phenyl)(H)C(OH)—P(═O)(ONH₄)—C(OH)(phenyl)(methyl), ((CH₂)₂CO₂H)(H)C(OH)—P(═O)(ONa)—C(OH)(phenyl)(methyl), (methyl)(methyl)C(OH)—P(═O)(OK)—C(OH)(phenyl)(methyl), ((CH₂)₂CO₂H)(methyl)C(OH)—P(═O)(ONH₄)—C(OH)(phenyl)(methyl), (phenyl)(phenyl)C(OH)—P(═O)(ONa)—C(OH)(phenyl)(methyl), (methyl)((CH₂)₂CO₂H)C(OH)—P(═O)(OK)—C(OH)(phenyl)(methyl), (phenyl)((CH₂)₂CO₂H)C(OH)—P(═O)(ONH₄)—C(OH)(phenyl)(methyl), ((CH₂)₂CO₂H)((CH₂)₂CO₂H)C(OH)—P(═O)(ONa)—C(OH)(phenyl)(methyl), (methyl)(H)C(OH)—P(═O)(OK)—C(OH)((CH₂)₂CO₂H)(methyl), (phenyl)(H)C(OH)—P(═O)(ONH₄)—C(OH)((CH₂)₂CO₂H)(methyl), ((CH₂)₂CO₂H)(H)C(OH)—P(═O)(ONa)—C(OH)((CH₂)₂CO₂H)(methyl), (phenyl)(phenyl)C(OH)—P(═O)(OK)—C(OH)((CH₂)₂CO₂H)(methyl), (phenyl)((CH₂)₂CO₂H)C(OH)—P(═O)(ONH₄)—C(OH)((CH₂)₂CO₂H)(methyl), ((CH₂)₂CO₂H)((CH₂)₂CO₂H)C(OH)—P(═O)(ONa)—C(OH)((CH₂)₂CO₂H)(methyl), (methyl)(H)C(OH)—P(═O)(OK)—C(OH)(phenyl)(phenyl), (phenyl)(H)C(OH)—P(═O)(ONH₄)—C(OH)(phenyl)(phenyl), ((CH₂)₂CO₂H)(H)C(OH)—P(═O)(ONa)—C(OH)(phenyl)(phenyl), (phenyl)(methyl)C(OH)—P(═O)(OK)—C(OH)(phenyl)(phenyl), ((CH₂)₂CO₂H)(phenyl)C(OH)—P(═O)(ONH₄)—C(OH)(phenyl)(phenyl), (methyl)((CH₂)₂CO₂H)C(OH)—P(═O)(ONa)—C(OH)(phenyl)(phenyl), (phenyl)((CH₂)₂CO₂H)C(OH)—P(═O)(OK)—C(OH)(phenyl)(phenyl), ((CH₂)₂CO₂H)((CH₂)₂CO₂H)C(OH)—P(═O)(ONH₄)—C(OH)(phenyl)(phenyl), (methyl)(H)C(OH)—P(═O)(ONa)—C(OH)(phenyl)((CH₂)₂CO₂H), (phenyl)(H)C(OH)—P(═O)(OK)—C(OH)(phenyl)((CH₂)₂CO₂H), ((CH₂)₂CO₂H)(H)C(OH)—P(═O)(ONH₄)—C(OH)(phenyl)((CH₂)₂CO₂H), (phenyl)(methyl)C(OH)—P(═O)(ONa)—C(OH)(phenyl)((CH₂)₂CO₂H), ((CH₂)₂CO₂H)(methyl)C(OH)—P(═O)(OK)—C(OH)(phenyl)((CH₂)₂CO₂H), ((CH₂)₂CO₂H)((CH₂)₂CO₂H)C(OH)—P(═O)(ONH₄)—C(OH)(phenyl)((CH₂)₂CO₂H), (methyl)(H)C(OH)—P(═O)(ONa)—C(OH)((CH₂)₂CO₂H)((CH₂)₂CO₂H), (phenyl)(H)C(OH)—P(═O)(OK)—C(OH)((CH₂)₂CO₂H)((CH₂)₂CO₂H), ((CH₂)₂CO₂H)(H)C(OH)—P(═O)(ONH₄)—C(OH)((CH₂)₂CO₂H)((CH₂)₂CO₂H), (methyl)(methyl)C(OH)—P(═O)(ONa)—C(OH)((CH₂)₂CO₂H)((CH₂)₂CO₂H), (phenyl)(methyl)C(OH)—P(═O)(OK)—C(OH)((CH₂)₂CO₂H)((CH₂)₂CO₂H), ((CH₂)₂CO₂H)(methyl)C(OH)—P(═O)(ONH₄)—C(OH)((CH₂)₂CO₂H)((CH₂)₂CO₂H), (methyl)(phenyl)C(OH)—P(═O)(ONa)—C(OH)((CH₂)₂CO₂H)((CH₂)₂CO₂H), (phenyl)(phenyl)C(OH)—P(═O)(OK)—C(OH)((CH₂)₂CO₂H)((CH₂)₂CO₂H), ((CH₂)₂CO₂H)(phenyl)C(OH)—P(═O)(ONH₄)—C(OH)((CH₂)₂CO₂H)((CH₂)₂CO₂H), (methyl)((CH₂)₂CO₂H)C(OH)—P(═O)(ONa)—C(OH)((CH₂)₂CO₂H)((CH₂)₂CO₂H), (phenyl)((CH₂)₂CO₂H)C(OH)—P(═O)(OK)—C(OH)((CH₂)₂CO₂H)((CH₂)₂CO₂H), ((CH₂)₂CO₂H)((CH₂)₂CO₂H)C(OH)—P(═O)(ONH₄)—C(OH)((CH₂)₂CO₂H)((CH₂)₂CO₂H).

Other inventive compounds are the following salts of asymmetrically substituted phosphinic acids:

(H)(H)C(OH)—P(═O)(OAl_{1/3})—C(OH)(H)(methyl), (H)(H)C(OH)—P(═O)(OZn_{1/2})—C(OH)(H)(phenyl), (H)(H)C(OH)—P(═O)(OAl_{1/3})—C(OH)(H)((CH₂)₂CO₂H), (H)(H)C(OH)—P(═O)(OMg_{1/2})—C(OH)(methyl)(methyl), (H)(H)C(OH)—P(═O)(OAl_{1/3})—C(OH)(phenyl)(methyl), (H)(H)C(OH)—P(═O)(OCa_{1/2})—C(OH)((CH₂)₂CO₂H)(methyl), (H)(H)C(OH)—P(═O)(OAl_{1/3})—C(OH)(phenyl)(phenyl), (H)(H)C(OH)—P(═O)(OTi_{1/3})—C(OH)(phenyl)((CH₂)₂CO₂H), (H)(H)C(OH)—P(═O)(OAl_{1/3})—C(OH)((CH₂)₂CO₂H)((CH₂)₂CO₂H), (H)(phenyl)C(OH)—P(═O)(OZn_{1/2})—C(OH)(H)(methyl), (H)((CH₂)₂CO₂H)C(OH)—P(═O)(OAl_{1/3})—C(OH)(H)(methyl), (H)(methyl)C(OH)—P(═O)(OAl_{1/3})—C(OH)(H)(phenyl), (H)(methyl)C(OH)—P(═O)(OMg_{1/2})—C(OH)(H)((CH₂)₂CO₂H), (H)(phenyl)C(OH)—P(═O)(OAl_{1/3})—C(OH)(H)((CH₂)₂CO₂H), (H)(H)C(OH)—P(═O)(OCa_{1/2})—C(OH)(methyl)(methyl), (H)(methyl)C(OH)—P(═O)(OAl_{1/3})—C(OH)(methyl)(methyl), (H)(phenyl)C(OH)—P(═O)(OCe_{1/3})—C(OH)(methyl)(methyl), (H)((CH₂)₂CO₂H)C(OH)—P(═O)(OAl_{1/3})—C(OH)(methyl)(methyl), (H)(H)C(OH)—P(═O)(OZn_{1/2})—C(OH)(phenyl)(methyl), (H)(methyl)C(OH)—P(═O)(OAl_{1/3})—C(OH)(phenyl)(methyl), (H)(phenyl)C(OH)—P(═O)(OMg_{1/2})—C(OH)(phenyl)(methyl), (H)((CH₂)₂CO₂H)C(OH)—P(═O)(OAl_{1/3})—C(OH)(phenyl)(methyl), (H)(H)C(OH)—P(═O)(OCa_{1/2})—C(OH)((CH₂)₂CO₂H)(methyl), (H)(methyl)C(OH)—P(═O)(OAl_{1/3})—C(OH)((CH₂)₂CO₂H)(methyl), (H)(phenyl)C(OH)—P(═O)(OTi_{1/3})—C(OH)((CH₂)₂CO₂H)(methyl), (H)((CH₂)₂CO₂H)C(OH)—P(═O)(OAl_{1/3})—C(OH)((CH₂)₂CO₂H)(methyl), (H)(H)C(OH)—P(═O)(OZn_{1/2})—C(OH)(phenyl)(phenyl), (H)(methyl)C(OH)—P(═O)(OAl_{1/3})—C(OH)(phenyl)(phenyl), (H)(phenyl)C(OH)—P(═O)(OMg_{1/2})—C(OH)(phenyl)(phenyl), (H)((CH₂)₂CO₂H)C(OH)—P(═O)(OAl_{1/3})—C(OH)(phenyl)(phenyl), (H)(H)C(OH)—P(═O)(OCa_{1/2})—C(OH)(phenyl)((CH₂)₂CO₂H), (H)(methyl)C(OH)—P(═O)(OAl_{1/3})—C(OH)(phenyl)((CH₂)₂CO₂H), (H)(phenyl)C(OH)—P(═O)(OCe_{1/3})—C(OH)(phenyl)((CH₂)₂CO₂H), (H)((CH₂)₂CO₂H)C(OH)—P(═O)(OAl_{1/3})—C(OH)(phenyl)((CH₂)₂CO₂H), (H)(H)C(OH)—P(═O)(OZn_{1/2})—C(OH)((CH₂)₂CO₂H)((CH₂)₂CO₂H), (H)(methyl)C(OH)—P(═O)(OAl_{1/3})—C(OH)((CH₂)₂CO₂H)((CH₂)₂CO₂H), (H)(phenyl)C(OH)—P(═O)(OMg_{1/2})—C(OH)((CH₂)₂CO₂H)((CH₂)₂CO₂H), (H)((CH₂)₂CO₂H)C(OH)—P(═O)(OAl_{1/3})—C(OH)((CH₂)₂CO₂H)((CH₂)₂CO₂H), (phenyl)(methyl)C(OH)—P(═O)(OCa_{1/2})—C(OH)(methyl)(methyl), ((CH₂)₂CO₂H)(methyl)C(OH)—P(═O)(OAl_{1/3})—C(OH)(methyl)(methyl), (methyl)(phenyl)C(OH)—P(═O)(OTi_{1/3})—C(OH)(methyl)(methyl), (phenyl)(phenyl)C(OH)—P(═O)(OAl_{1/3})—C(OH)(methyl)(methyl), ((CH₂)₂CO₂H)(phenyl)C(OH)—P(═O)(OZn_{1/2})—C(OH)(methyl)(methyl), (methyl)((CH₂)₂CO₂H)C(OH)—P(═O)(OAl_{1/3})—C(OH)(methyl)(methyl), (phenyl)((CH₂)₂CO₂H)C(OH)—P(═O)(OMg_{1/2})—C(OH)(methyl)(methyl), ((CH₂)₂CO₂H)((CH₂)₂CO₂H)C(OH)—P(═O)(OAl_{1/3})—C(OH)(methyl)(methyl), (methyl)(H)C(OH)—P(═O)(OCa_{1/2})—C(OH)(phenyl)(methyl), (phenyl)(H)C(OH)—P(═O)(OAl_{1/3})—C(OH)(phenyl)(methyl), ((CH₂)₂CO₂H)(H)C(OH)—P(═O)(OCe_{1/3})—C(OH)(phenyl)(methyl), (methyl)(methyl)C(OH)—P(═O)(OAl_{1/3})—C(OH)(phenyl)(methyl), ((CH₂)₂CO₂H)(methyl)C(OH)—P(═O)(OZn_{1/2})—C(OH)(phenyl)(methyl), (phenyl)(phenyl)C(OH)—P(═O)(OAl_{1/3})—C(OH)(phenyl)(methyl), (methyl)((CH₂)₂CO₂H)C(OH)—P(═O)(OMg_{1/2})—C(OH)(phenyl)(methyl), (phenyl)((CH₂)₂CO₂H)C(OH)—P(═O)(OAl_{1/3})—C(OH)(phenyl)(methyl), ((CH₂)₂CO₂H)((CH₂)₂CO₂H)C(OH)—P(═O)(OCa_{1/2})—C(OH)(phenyl)(methyl), (methyl)(H)C(OH)—P(═O)(OAl_{1/3})—C(OH)((CH₂)₂CO₂H)(methyl), (phenyl)(H)C(OH)—P(═O)(OTi_{1/3})—C(OH)((CH₂)₂CO₂H)(methyl), ((CH₂)₂CO₂H)(H)C(OH)—P(═O)(OAl_{1/3})—C(OH)((CH₂)₂CO₂H)(methyl), (phenyl)(phenyl)C(OH)—P(═O)(OZn_{1/2})—C(OH)((CH₂)₂CO₂H)(methyl), (phenyl)((CH₂)₂CO₂H)C(OH)—P(═O)(OAl_{1/3})—C(OH)((CH₂)₂CO₂H)(methyl), ((CH₂)₂CO₂H)((CH₂)₂CO₂H)C(OH)—P(═O)(OMg_{1/2})—C(OH)((CH₂)₂CO₂H)(methyl), (methyl)(H)C(OH)—P(═O)(OAl_{1/3})—C(OH)(phenyl)(phenyl), (phenyl)(H)C(OH)—P(═O)(OCa_{1/2})—C(OH)(phenyl)(phenyl), ((CH₂)₂CO₂H)(H)C(OH)—P(═O)(OAl_{1/3})—C(OH)(phenyl)(phenyl), (phenyl)(methyl)C(OH)—P(═O)(OCe_{1/3})—C(OH)(phenyl)(phenyl), ((CH₂)₂CO₂H)(phenyl)C(OH)—P(═O)(OAl_{1/3})—C(OH)(phenyl)(phenyl), (methyl)((CH₂)₂CO₂H)C(OH)—P(═O)(OZn_{1/2})—C(OH)(phenyl)(phenyl), (phenyl)((CH₂)₂CO₂H)C(OH)—P(═O)(OAl_{1/3})—C(OH)(phenyl)(phenyl), ((CH₂)₂CO₂H)((CH₂)₂CO₂H)C(OH)—P(═O)(OMg_{1/2})—C(OH)(phenyl)(phenyl), (methyl)(H)C(OH)—P(═O)(OAl_{1/3})—C(OH)(phenyl)((CH₂)₂CO₂H), (phenyl)(H)C(OH)—P(═O)(OCa_{1/2})—C(OH)(phenyl)((CH₂)₂CO₂H), ((CH₂)₂CO₂H)(H)C(OH)—P(═O)(OAl_{1/3})—C(OH)(phenyl)((CH₂)₂CO₂H), (phenyl)(methyl)C(OH)—P(═O)(OTi_{1/3})—C(OH)(phenyl)((CH₂)₂CO₂H), ((CH₂)₂CO₂H)(methyl)C(OH)—P(═O)(OAl_{1/3})—C(OH)(phenyl)((CH₂)₂CO₂H), ((CH₂)₂CO₂H)((CH₂)₂CO₂H)C(OH)—P(═O)(OZn_{1/2})—C(OH)(phenyl)((CH₂)₂CO₂H), (methyl)(H)C(OH)—P(═O)(OAl_{1/3})—C(OH)((CH₂)₂CO₂H)((CH₂)₂CO₂H), (phenyl)(H)C(OH)—P(═O)(OMg_{1/2})—C(OH)((CH₂)₂CO₂H)((CH₂)₂CO₂H), ((CH₂)₂CO₂H)(H)C(OH)—P(═O)(OAl_{1/3})—C(OH)((CH₂)₂CO₂H)((CH₂)₂CO₂H), (methyl)(methyl)C(OH)—P(═O)(OCa_{1/2})—C(OH)((CH₂)₂CO₂H)((CH₂)₂CO₂H), (phenyl)(methyl)C(OH)—P(═O)(OAl_{1/3})—C(OH)((CH₂)₂CO₂H)((CH₂)₂CO₂H), ((CH₂)₂CO₂H)(methyl)C(OH)—P(═O)(OCe_{1/3})—C(OH)((CH₂)₂CO₂H)((CH₂)₂CO₂H), (methyl)(phenyl)C(OH)—P(═O)(OAl_{1/3})—C(OH)((CH₂)₂CO₂H)((CH₂)₂CO₂H), (phenyl)(phenyl)C(OH)—P(═O)(OZn_{1/2})—C(OH)((CH₂)₂CO₂H)((CH₂)₂CO₂H), ((CH₂)₂CO₂H)(phenyl)C(OH)—P(═O)(OAl_{1/3})—C(OH)((CH₂)₂CO₂H)((CH₂)₂CO₂H), (methyl)((CH₂)₂CO₂H)C(OH)—P(═O)(OMg_{1/2})—C(OH)((CH₂)₂CO₂H)((CH₂)₂CO₂H), (phenyl)((CH₂)₂CO₂H)C(OH)—P(═O)(OAl_{1/3})—C(OH)((CH₂)₂CO₂H)((CH₂)₂CO₂H), ((CH₂)₂CO₂H)((CH₂)₂CO₂H)C(OH)—P(═O)(OCa_{1/2})—C(OH)((CH₂)₂CO₂H)((CH₂)₂CO₂H).

It is preferable that the salts of the inventive asymmetrically substituted phosphinic acids have residual moisture levels of from 0.01 to 10% by weight, particularly from to 1% by weight.

It is preferable that salts of the inventive asymmetrically substituted phosphinic acids have average particle sizes of from 0.1 to 2000 μm, particularly from 10 to 500 μm.

It is preferable that the salts of the inventive asymmetrically substituted phosphinic acids have bulk densities of from 80 to 800 g/l, particularly from 200 to 700 g/l.

It is preferable that the salts of the inventive asymmetrically substituted phosphinic acids have decomposition temperatures of from 150 to 300° C., particularly from 160 to 250° C.

It is preferable that the inventive process reacts an asymmetrically substituted phosphinic acid in a solvent system with a reactant A, where the reactant A is preferably prepared from a precursor.

It is preferable to use a closed-circuit method when carrying out the inventive processes, by isolating the salts of asymmetrically substituted phosphinic acids and reusing the resultant mother liquor.

In the closed-circuit method, it is preferable that fresh phosphinic acids, reactant A, and solvent are added, and the reaction repeated.

In the closed-circuit method, it is preferable that the reactant A is prepared from a precursor.

The closed-circuit method is preferably a method of batchwise or continuous operation.

It is preferable that the reaction of the asymmetrically substituted phosphinic acid with reactant A is carried out with a solids content of the salts of asymmetrically substituted phosphinic acids of from 0.1 to 70% by weight, preferably from 5 to 40% by weight.

The reaction is preferably carried out at a temperature of from −20 to +500° C., particularly preferably from 70 to 160° C.

It is preferable that the ratio of reactant A to phosphorus (of the asymmetrically substituted phosphinic acid) is from 0.8 to 3 ion equivalents (mol per cation charge), particularly from 1 to 2.

It is preferable that the ratio of solvent to phosphorus (of the asymmetrically substituted phosphinic acid) is from 2 to 1000 mol/mol, particularly from 4 to 100 mol/mol.

Asymmetrically substituted phosphinic acids preferred as starting materials are of A-P(═O)OH—B type, where A and B are as defined in formula (I).

A preferred solvent system comprises, by virtue of autodissociation, anions identical with those in reactant A.

A preferred solvent system has a dissociation constant pKa of from 10 to 30.

Preferred solvents are alcohols, e.g. methanol, ethanol, isopropanol, n-propanol, n-butanol, isobutanol, tert-butanol, n-amyl alcohol, isoamyl alcohol, tert-amyl alcohol, n-hexanol, n-octanol, isooctanol, n-tridecanol, benzyl alcohol, etc. Preference is also given to glycols, e.g. ethylene glycol, 1,2-propanediol, 1,3-propanediol, 1,3-butanediol, 1,4-butanediol, diethylene glycol etc.

Preferred reactant A is a salt of an element of the first main group, preferably an alkali metal hydroxide, alkali metal oxide hydroxide, alkali metal hydroxide carbonate, alkali metal alcoholate, particularly lithium hydroxide, sodium hydroxide, potassium hydroxide, sodium methoxide, sodium ethoxide, sodium n-propoxide, sodium isopropoxide, sodium n-butoxide, sodium isobutoxide, sodium tert-butoxide, sodium amyl alcoholate, and/or sodium glycolate.

Another preferred reactant A is a salt of an element of the first main group, preferably an element of the second main and transition group, preferably alkaline earth metal hydroxide, alkaline earth metal oxide hydroxide, alkaline earth metal hydroxide carbonate, particularly magnesium hydroxide (Magnifin® H5, Albemarle), hydrotalcite (Mg₆Al₂(OH)₁₆CO₃*nH₂O), dihydrotalcite, magnesium carbonates or magnesium calcium-carbonates, calcium hydroxide, basic zinc carbonate, zinc hydroxide carbonate, basic zinc carbonate hydrate, zinc hydroxides, or mixed zinc oxide hydroxides (standard zinc oxide, e.g. from Grillo, activated zinc oxide, e.g. from Rheinchemie, zincite, calamine), and the corresponding hydroxystannate, inter alia.

Another preferred reactant A is a salt of an element of the third main and transition group, preferably aluminum hydroxide, cerium hydroxide, lanthanum hydroxide, aluminum alcoholate, cerium alcoholate, lanthanum alcoholate, aluminum hydroxide, or mixed aluminum oxide hydroxide, dihydroxyaluminum sodium carbonate, NaAl(OH)₂CO₃ and/or polyaluminum hydroxy compounds, whose aluminum content is preferably from 9% to 40% by weight.

Another preferred reactant A is a salt of an element of the fourth main and transition group, preferably tin hydroxides, lead hydroxides, titanium oxide hydroxides, zirconium oxide hydroxides, tin alcoholates, titanium alcoholates, or zirconium alcoholates.

Preferred titanium alcoholates, i.e. titanium alkoxides, are titanium(IV) n-propoxide (Tilcom® NPT, Vertece NPT), titanium(IV) n-butoxide, titanium chloride triisopropoxide, titanium(IV) ethoxide, or titanium(IV) 2-ethylhexoxide (Tilcom® EHT, Vertetec® EHT).

Preferred tin alcoholate (tin alkoxide), is tin(IV) tert-butoxide.

Preferred zirconium alcoholate, i.e. zirconium alkoxide, is zirconium(IV) tert-butoxide.

Preferred precursors are an element of the first main group, preferably Li, Na, or K, in the elemental, metallic form, or as oxide, peroxide, or superoxide, or an element of the second main and transition group, preferably Mg, Ca, or Zn, in the elemental, metallic form, or as oxide or peroxide. Preference is given to zinc peroxides, zinc oxides (e.g. activated zinc oxide from Rhein Chemie or Brüggemann KG, zincite or calamine; standard zinc oxide, G6 zinc white, 2011 zinc oxide, F-80 zinc oxide, Pharma 8 zinc white®, Pharma A zinc white®, Rotsiegel zinc white®, Weissiegel zinc white® from Grillo-Werke AG), an element of the third main and transition group, preferably Al, Ce, or La, in the elemental, metallic form, or as oxide or peroxide, or an element of the fourth main and transition group, preferably Sn, Pb, Ti or Zr, in the elemental, metallic form, or as oxide or peroxide.

It is preferable that in an inventive process 2 the inventive salt of the asymmetrically substituted bis(1-hydroxymethyl)phosphinic acid is converted into another metal salt via addition of another reactant B.

Preferred reactants B are borates, carbonates, hydroxocarbonates, hydroxocarbonate hydrates, mixed hydroxocarbonates, mixed hydroxocarbonate hydrates, phosphates, sulfates, sulfate hydrates, hydroxosulfate hydrates, mixed hydroxosulfate hydrates, oxysulfates, acetates, nitrates, fluorides, fluoride hydrates, chloride, chloride hydrates, oxychlorides, bromides, iodides, iodide hydrates, carboxylic acid derivatives, and/or alkoxides of an element of the first main group, of the second main and transition group—preferably Mg, Ca, or Zn—of the third main and transition group—preferably Al, Ce, or La—or of the fourth main and transition group, preferably Sn, Pb, Ti, or Zr.

Preferred reactants B are aluminum chloride, aluminum nitrate, aluminum sulfate, titanyl sulfate, zinc nitrate, and/or zinc sulfate.

It is preferable that the reaction takes place in a stirred tank, mixer, and/or kneader.

It is preferable that the reaction in the inventive processes is carried out with energy input of from 0.083 to 1.65 kW/m³, particularly preferably from 0.33 to 1.65 kW/m³.

It is preferable that the salts of the asymmetrically substituted phosphinic acids are isolated in the inventive process via filtering and/or centrifuging from the reaction mixture.

It is preferable that the salts of the asymmetrically substituted phosphinic acids in the inventive process are isolated using pressure filter funnels, vacuum filter funnels, filter funnels with stirrer, pressure rise candle filters, axial leaf filters, circular leaf filters, centrifugal leaf filters, chamber-frame filter presses, automatic chamber filter presses, vacuum multicompartment drum filters, vacuum multicompartment leaf filters, vacuum horizontal-table filters, side-feed vacuum filters, rotation pressure filters, or vacuum belt filters.

It is preferable that the filtration pressure is from 0.5 Pa to 6 MPa.

It is preferable that the filtration temperature is from 0 to 400° C.

It is preferable that the specific filter rate is from 10 to 200 kg*h⁻¹*m⁻².

It is preferable that the residual moisture level of the filter cake is from 5 to 60%.

It is preferable that the salts of the asymmetrically substituted phosphinic acids in the inventive processes are isolated using solid-wall centrifuges, such as overflow centrifuges, plough centrifuges, chamber centrifuges, helical-conveyor centrifuges, disc centrifuges, tube centrifuges, sieve centrifuges, such as overdriven centrifuges and underdrive centrifuges, screen-conveyor centrifuges, screen-plough centrifuges, or reciprocating-conveyor centrifuges.

It is preferable that the acceleration ratio is from 300 to 15 000.

It is preferable that the suspension throughput rate is from 2 to 400 m³*h⁻¹.

It is preferable that the solids throughput rate is from 5 to 80 t*h⁻¹.

It is preferable that the residual moisture level of the cake is from 5 to 60%.

It is preferable that the salts of the asymmetrically substituted phosphinic acids in the inventive processes are dried.

Suitable assemblies for the drying process are chamber dryers, channel dryers, belt dryers, (air velocity from 2 to 3 m/s), disc dryers (temperature from 20 to 400° C.), drum dryers (hot gas temperature from 100 to 250° C.), paddle dryers (temperature from 50 to 300° C.), pneumatic dryers (air velocity from 10-60 m/s, exhaust air temperature from 50 to 300° C.), fluidized-bed dryers (air velocity from 0.2 to 0.5 m/s, exhaust air temperature from 50 to 300° C.), cylinder dryers, tubular dryers (temperature from 20 to 200° C.), paddle dryers, vacuum drying cabinets (temperature from 20 to 300° C., pressure from 0.001 to 0.016 MPa), vacuum-drum dryers (temperature from 20 to 300° C., pressure from 0.004 to 0.014 MPa), vacuum paddle dryers (temperature from 20 to 300° C., pressure from 0.003 to 0.02 MPa), vacuum conical dryers (temperature from 20 to 300° C., pressure from 0.003 to 0.02 MPa).

Surprisingly, it has been found that the decomposition temperature of the inventive salts of asymmetrically substituted phosphinic acids is lower than that of the comparable salts of symmetrically substituted bis(1-hydroxymethyl)phosphinic acids or salts of dialkylphosphinic acids. They therefore have flame-retardant activity at substantially lower temperatures than the representatives of the prior art.

It is therefore preferable that the inventive salts of asymmetrically substituted phosphinic acids are used as boosters or synergists in flame retardants, or are used alone as flame retardants.

It is preferable that the inventive salts of asymmetrically substituted phosphinic acids are used as boosters or synergists in flame retardants, or are used alone as flame retardants, in clear lacquers and intumescent coatings, for wood and other cellulose-containing products, or as reactive and/or non-reactive boosters or synergists in flame retardants, or are used alone as flame retardants for polymers.

It is preferable that the inventive salts of asymmetrically substituted phosphinic acids are used for the preparation of flame-retardant polymer molding compositions, for the production of flame-retardant polymer moldings, or for providing flame retardancy to polyester and unblended or blended cellulose textiles via impregnation.

It is preferable that the inventive salts of asymmetrically substituted phosphinic acids are used for the preparation of flame-retardant polymer molding compositions.

It is preferable that the polymer is a thermoplastic or thermoset polymer.

It is preferable that the inventive salts of asymmetrically substituted phosphinic acids are used for the preparation of flame-retardant thermoplastic polymer molding compositions.

It is preferable that the flame-retardant thermoplastic polymer molding composition comprises from 0.5 to 45% by weight of inventive salts of asymmetrically substituted phosphinic acids.

It is preferable that the flame-retardant thermoplastic polymer molding composition comprises from 0.5 to 45% by weight of inventive salts of asymmetrically substituted phosphinic acids, and from 0.5 to 95% by weight of thermoplastic polymer, or a mixture of these, where the entirety of the components is 100% by weight.

It is preferable that the flame-retardant thermoplastic polymer molding composition comprises from 0.5 to 45% by weight of inventive salts of asymmetrically substituted phosphinic acids, from 0.5 to 95% by weight of thermoplastic polymer, or a mixture of these, from 0.5 to 55% by weight of additives, and from 0.5 to 55% by weight of fillers or of reinforcing materials, where the entirety of the components is 100% by weight.

It is preferable that the flame-retardant thermoplastic polymer molding composition comprises from 10 to 40% by weight of inventive salts of asymmetrically substituted phosphinic acids, from 10 to 80% by weight of thermoplastic polymer, or a mixture of these, from 2 to 40% by weight of additives, from 2 to 40% by weight of fillers or of reinforcing materials, where the entirety of the components is 100% by weight.

A process for the preparation of flame-retardant thermoplastic polymer molding compositions comprises mixing the inventive asymmetrically substituted phosphinic acid with the polymer pellets and optionally with additives, and incorporating it in a twin-screw extruder (ZSK® 25 WLE, 14.5 kg/h, 200 rpm, L/D: 4) at inventive temperatures of 170° C. (polystyrene), about 270° C. (PET, polyethylene terephthalate), from 230 to 260° C. (polybutylene terephthalate, PBT), from 260° C. (PA6) or from 260 to 280° C. (PA 66). The homogenized polymer strand is drawn off, cooled in a waterbath, then pelletized, and dried to a residual moisture level of from 0.05 to 5%, preferably from 0.1 to 1% by weight.

It is preferable that the thermoplastic polymers are polymers of mono- and diolefins, for example polypropylene, polyisobutylene, poly-1-butene, poly-4-methyl-1-pentene, polyisoprene, and polybutadiene, or else polymers of cycloolefins, e.g. of cyclopentene or norbomene; or polyethylene (which may, where appropriate, have been crosslinked), e.g. high-density polyethylene (HDPE), high-density high-molecular-weight polyethylene (HMWHDPE), high-density ultrahigh-molecular-weight polyethylene (UHMWHDPE), medium-density polyethylene (MDPE), low-density polyethylene (LDPE), linear low-density polyethylene (LLDPE), or branched low-density polyethylene (VLDPE), or a mixture thereof.

It is preferable that the thermoplastic polymers are copolymers of mono- and diolefins with one another or with other vinyl monomers, e.g. ethylene-propylene copolymers, linear low-density polyethylene (LLDPE), or a mixture of this with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and their copolymers with carbon monoxide, or ethylene-acrylic acid copolymers and their salts (ionomers), or else terpolymers of ethylene with propylene and with a diene, such as hexadiene, dicyclopentadiene, or ethylidenenorbornene; or a mixture of these copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene acrylic acid copolymers, and alternating or random-structure polyalkylene/carbon monoxide copolymers, or a mixture of these with other polymers, e.g. with polyamides.

It is preferable that the polymers are hydrocarbon resins (e.g. C₅-C₉) inclusive of hydrogenated modifications thereof (e.g. tackifier resins), and mixtures of polyalkylenes and starch.

It is preferable that the thermoplastic polymers are polystyrene, poly(p-methylstyrene), and/or poly(alpha-methylstyrene).

It is preferable that the thermoplastic polymers are copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate and the corresponding methacrylate, styrene-maleic anhydride, styrene-acrylonitrile-methyl acrylate; a mixture of high impact resistance composed of styrene copolymers and of another polymer, e.g. of a polyacrylate, of a diene polymer, or of an ethylene-propylene-diene terpolymer; or else block copolymers of styrene, e.g. styrene-butadiene-styrene, styrene-isoprene-styrene, styrene-ethylene/butylene-styrene, or styrene-ethylene/propylene-styrene.

It is preferable that the thermoplastic polymers are graft copolymers of styrene or alpha-methylstyrene, e.g. styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, or else a mixture of these, for example that known as ABS polymer, MBS polymers, ASA polymer, or AES polymer.

It is preferable that the thermoplastic polymers are halogen-containing polymers, e.g. polychloroprene, chlorinated rubber, chlorinated and brominated copolymer composed of isobutylene-isoprene (halobutyl rubber), chlorinated or chlorosulfonated polyethylene, copolymers of ethylene and of chlorinated ethylene, epichlorohydrinhomo- and copolymers, in particular polymers composed of halogen-containing vinyl compounds, e.g. polyvinyl chloride, polyvinylidene chloride, polyvinyl fluoride, polyvinylidene fluoride; or else copolymers of these, such as vinyl chloride-vinylidene chloride, vinyl chloride-vinyl acetate, or vinylidene chloride-vinyl acetate.

It is preferable that the thermoplastic polymers are polymers which derive from alpha-beta-unsaturated acids and from their derivatives, e.g. polyacrylates and polymethacrylates, butyl-acrylate-impact-modified polymethyl methacrylates, polyacrylamides and polyacrylonitriles, and copolymers of the monomers mentioned with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, or acrylonitrile-alkyl methacrylate-butadiene terpolymers.

It is preferable that the thermoplastic polymers are polymers which derive from unsaturated alcohols and amines or from their acyl derivatives or acetals, e.g. polyvinyl alcohol, polyvinyl acetate, polyvinyl stearate, polyvinyl benzoate, polyvinyl maleate, polyvinyl butyral, polyallyl phthalate, polyallylmelamine; or else their copolymers with olefins.

It is preferable that the thermoplastic polymers are homo- and copolymers of cyclic ethers, e.g. polyalkylene glycols, polyethylene oxide, polypropylene oxide, or their copolymers with bisglycidyl ethers.

It is preferable that the polymers are thermoplastic polyacetals, such as polyoxymethylene, or else those polyoxymethylenes which contain comonomers, e.g. ethylene oxide; polyacetals modified with thermoplastic polyurethanes, or with acrylates, or with MBS.

It is preferable that the thermoplastic polymers are polyphenylene oxides and polyphenylene sulfides, and their mixtures with styrene polymers or with polyamides.

The thermoplastic polymers are preferably polyurethanes which derive firstly from polyethers, polyesters, and polybutadienes having terminal hydroxy groups, and secondly from aliphatic or aromatic polyisocyanates, or else are precursors of these.

It is preferable that the thermoplastic polymers are polyamides and copolyamides derived from diamines and dicarboxylic acids, and/or from aminocarboxylic acids, or from the corresponding lactams, for example nylon-4, nylon-6 (Akulon® K122, DSM; Zytel® 7301, DuPont; Durethan® B 29, Bayer), nylon-6,6 (Zytel® 101, DuPont; Durethan® A30, Durethan® AKV, Durethan® AM, Bayer; Ultramid® A3, BASF) -6,10, -6,9, -6,12, -4,6, -12,12, nylon-11, and nylon-12 (Grillamid® L20, Ems Chemie), aromatic polyamides based on m-xylene, diamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing “RIM polyamide systems”).

It is preferable that the polymers are polyureas, polyimides, polyamideimides, polyetherimides, polyesterimides, polyhydantoins and polybenzimidazoles.

It is preferable that the thermoplastic polymers are polyesters which derive from dicarboxylic acids and dialcohols and/or from hydroxycarboxylic acids, or from the corresponding lactones, for example polyethylene terephthalate, polybutylene terephthalate (Celanex® 2500, Celanex® 2002, Celanese; Ultradur®, BASF), poly-1,4-dimethylolcyclohexane terephthalate, polyhydroxybenzoates, and also block polyetheresters which derive from polyethers having hydroxyl end groups; as well as polyesters modified with polycarbonates or with MBS.

It is preferable that the thermoplastic polymers are polycarbonates or polyester carbonates, or else polysulfones, polyether sulfones, or polyether ketones.

It is preferable that the polymers are mixtures (polyblends) of the abovementioned polymers, e.g. PP/EPDM, nylon/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/nylon-6,6 and copolymers, PA/HDPE, PA/PP, PA/PPO, PBT/PC/ABS, and PBT/PET/PC.

It is preferable that the inventive salts of asymmetrically substituted phosphinic acids are used for the production of flame-retardant thermoplastic polymer moldings, of flame-retardant thermoplastic polymer films, of flame-retardant thermoplastic polymer filaments, and of flame-retardant thermoplastic polymer fibers.

It is preferable that the inventive flame-retardant thermoplastic molding compositions which comprise the salts of asymmetrically substituted phosphinic acids are used for the production of flame-retardant thermoplastic polymer moldings, of flame-retardant thermoplastic polymer films, of flame-retardant thermoplastic polymer filaments, and of flame-retardant thermoplastic polymer fibers.

It is preferable that the flame-retardant polymer moldings, flame-retardant polymer films, flame-retardant polymer filaments, and flame-retardant polymer fibers comprise from 0.5 to 45% by weight of inventive salts of asymmetrically substituted phosphinic acids, and from 0.5 to 95% by weight of thermoplastic polymer, or a mixture of these.

It is preferable that the flame-retardant polymer moldings, flame-retardant polymer films, flame-retardant polymer filaments, and flame-retardant polymer fibers comprise from 0.5 to 45% by weight of inventive salts of asymmetrically substituted phosphinic acids, from 0.5 to 95% by weight of thermoplastic polymer or a mixture of these, from 0.5 to 55% by weight of additives, and from 0.5 to 55% by weight of fillers or of reinforcing materials.

Finally, the invention also provides a process for the production of flame-retardant polymer moldings, which comprises processing inventive flame-retardant polymer molding compositions via injection molding (e.g. an injection-molding machine (Arburg Allrounder®) and compression molding, foam injection molding, internal-gas-pressure injection molding, blowmolding, cast-film production, calendering, lamination, or coating at relatively high temperatures to give the flame-retardant polymer molding.

In the process for production of flame-retardant polymer moldings, the inventive flame-retardant molding composition is processed at the following melt temperatures to give polymer moldings. Preferred melt temperatures are from 200 to 250° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), and from 280 to 320° C. for polycarbonate.

Preference is also given to the use of the inventive salts of asymmetrically substituted phosphinic acids for the preparation of flame-retardant thermoset polymer molding compositions.

This type of flame-retardant thermoset polymer molding composition comprises from from 0.1 to 45% by weight of inventive salts of asymmetrically substituted phosphinic acids, from 40 to 90% by weight of unsaturated polyester, and from 10 to 60% by weight of vinyl monomer.

The thermoset polymers are preferably unsaturated polyester resins which derive from copolyesters of saturated and unsaturated dicarboxylic acids or their anhydrides with polyhydric alcohols, or else vinyl compounds, as crosslinking agents. UP resins are hardened via free-radical polymerization using initiators (e.g. peroxides) and accelerators.

Preferred unsaturated dicarboxylic acids and unsaturated dicarboxylic acid derivatives for the preparation of the polyesters are maleic anhydride and fumaric acid.

Preferred saturated dicarboxylic acids are phthalic acid, isophthalic acid, terephthalic acid, tetrahydrophthalic acid, and/or adipic acids.

Preferred diols are 1,2-propanediol, ethylene glycol, diethylene glycol, and neopentyl glycol, neopentyl glycol, and ethoxylated or propoxylated bisphenol A.

Preferred vinyl compound for the crosslinking reaction is styrene.

Preferred hardender systems are peroxides and metal coinitiators, e.g. hydroperoxides, and cobalt octanoate, and/or benzoyl peroxide, and aromatic amines, and/or UV light and photosensitizers, e.g. benzoin ethers.

Preferred hydroperoxides are di-tert-butyl peroxide, tert-butyl peroctoate, tert-butyl perpivalate, tert-butyl 2-ethylperhexanoate, tert-butyl permaleate, tert-butyl periso-butyrate, benzoyl peroxide, diacetyl peroxide, succinyl peroxide, p-chlorobenzoyl peroxide, dicyclohexyl peroxydicarbonate.

It is preferable that the amounts used of initiators are from 0.1 to 20% by weight, with preference from 0.2 to 15% by weight, based on the weight of all the comonomers.

Preferred metal coinitiators are compounds of cobalt, of manganese, of iron, of vanadium, of nickel, or of lead. It is preferable to use amounts of from 0.05 to 1% by weight, based on the weight of all of the comonomers, of metal coinitiators.

Preferred aromatic amines are dimethylaniline, p-dimethyltoluene, diethylaniline and phenyldiethanolamines.

A process for the preparation of flame-retardant copolymers comprises copolymerizing polyol and at least one vinylaromatic compound, and at least one ethylenically unsaturated dicarboxylic anhydride derived from at least one C₄-C₈ dicarboxylic acid, and then reacting with inventive asymmetrically substituted phosphinic acid.

A process for the preparation of flame-retardant thermoset compositions comprises mixing a thermoset resin with a flame retardant component composed of inventive asymmetrically substituted phosphinic acid, and wet-pressing the resultant mixture at pressures of from 3 to 10 bar and temperatures of from 20 to 60° C. (cold pressing).

A process for the preparation of flame-retardant thermoset compositions comprises mixing a thermoset resin with inventive asymmetrically substituted phosphinic acid, and wet-pressing the resultant mixture at pressures of from 3 to 10 bar and temperatures of from 80 to 150° C. (warm or hot pressing).

It is preferable that the inventive flame-retardant thermoset molding compositions are used for the production of flame-retardant thermoset polymer moldings.

A flame-retardant epoxy resin comprises from 0.5 to 50% by weight of the inventive salts of asymmetrically substituted phosphinic acids, from 5 to 70% by weight of an epoxy resin, and from 0 to 20% by weight a hardener.

The polymers are preferably crosslinked epoxy resins which derive from aliphatic, cycloaliphatic, heterocyclic, or aromatic glycidyl compounds, e.g. products of bisphenol A diglycidyl ethers or of bisphenol F diglycidyl ethers, which are crosslinked by means of conventional hardeners and/or accelerators.

Suitable glycidyl compounds are bisphenol A diglycidyl ester, bisphenol F diglycidyl ester, polyglycidyl ester of phenol-formaldehyde resins and of cresol-formaldehyde resins, polyglycidyl ester of pththalic, isophthalic, and terephthalic acid, and also of trimellitic acid, N-glycidyl compounds of aromatic amines and of heterocyclic nitrogen bases, and also di- and polyglycidyl compounds of polyhydric aliphatic alcohols.

Suitable hardeners are polyamines, such as diethylenetriamine, triethylenetetramine, aminoethylpiperazine, isophoronediamine, polyamidoamine, diaminodiphenylmethane, diaminodiphenol sulfones, and dicyandiamide.

Suitable hardeners are polybasic acids or their anhydrides, e.g. phthalic anhydride, maleic anhydride, tetrahydrophthalic anhydride, methyltetrahydrophthalic anhydride, hexahydrophthalic anhydride, and methylhexahydrophthalic anhydride.

Suitable hardeners are phenols, e.g. phenol-novolak resin, cresol-novolak resin, dicyclopentadiene-phenol-adduct resin, phenol-aralkyl resin, cresol-aralkyl resin, naphthol-aralkyl resin, biphenol-modified phenol-aralkyl resin, phenol-trimethylolmethane resin, tetraphenylolethane resin, naphthol-novolak resin, naphthol-phenol cocondensate resin, naphthol-cresol cocondensate resin, biphenol-modified phenolic resin, and aminotriazine-modified phenolic resin.

These hardeners can be used alone or in combination with one another.

Suitable catalysts or accelerators for the crosslinking reaction during the polymerization reaction are tertiary amines, benzyldimethylamine, N-alkylpyridines, imidazole, 1-methylimidazole, 2-methylimidazole, 2-ethyl-4-methylimidazole, 2-ethyl-4-methylimidazole, 2-phenylimidazole, 2-heptadecylimidazole, a metal salt of organic acids, Lewis acids, and amine complex salts.

Epoxy resins are suitable for the potting of electrical or electronic components, and for saturation and impregnation processes. In electrical engineering, the epoxy resins used are mainly flame-retardant, and used for printed circuit boards and insulators.

It is preferable that the polymers are crosslinked polymers which derive on the one hand from aldehydes and on the other hand from phenols, urea, or melamine, examples being phenol-formaldehyde resins, urea-formaldehyde resins, and melamine-formaldehyde resins.

It is preferable that the polymers are crosslinkable acrylic resins which derive from substituted acrylates, e.g. from epoxy acrylates, from urethane acrylates, or from polyester acrylates.

It is preferable that the polymers are alkyd resins, polyester resins, and acrylate resins, crosslinked with melamine resins, with urea resins, with isocyanates, with isocyanurates, with polyisocyanates, or with epoxy resins.

It is preferable that the inventive flame-retardant epoxy resins are used for the production of flame-retardant thermoset polymer moldings.

The invention also provides a flame-retardant polyurethane molding composition, prepared via reaction of from 0.1 to 50 parts by weight of inventive asymmetrically substituted phosphinic acid with from 30 to 65 parts by weight of polyisocyanate, and from 30 to 65 parts by weight of polyol.

A process for the preparation of a flame-retardant polyurethane molding composition comprises reacting from 170 to 70 parts by weight, preferably from 130 to 80 parts by weight, of polyisocyanates with 100 parts by weight of polyol, with from 0.1 to 50 parts by weight of inventive asymmetrically substituted phosphinic acid, and with from 0.1 to 4 parts by weight, particularly preferably from 1 to 2 parts by weight, of catalyst, and optionally using from 0.1 to 1.8 parts by weight, preferably from 0.3 to 1.6 parts by weight, of blowing agent for foaming.

It is preferable that the inventive flame-retardant polyurethane molding compositions are used for the production of flame-retardant thermoset polymer moldings.

Preferred polyols are alkene oxide adducts of ethylene glycol, 1,2-propanediol, bisphenol A, trimethylolpropane, glycerol, pentaerythrol, sorbitol, sugars, degraded starch, ethylenediamine, diaminotoluene, and/or aniline, these serving as an initiator. The preferred alkoxylating agents contain from 2 to 4 carbon atoms, preference being given to ethylene oxide and propylene oxide.

Preferred polyester polyols are obtained via polycondensation of a polyalcohol, such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, glucose and/or sorbitol, with a dibasic acid, such as oxalic acid, malonic acid, succinic acid, tartaric acid, adipic acid, sebacic acid, maleic acid, fumaric acid, phthalic acid, terephthalic acid. These polyester polyols can be used alone or in combination.

Suitable polyisocyanates are aromatic, alicyclic, or aliphatic polyisocyanates having no fewer than two isocyanate groups, and mixtures thereof. Preference is given to aromatic polyisocyanates, such as tolyl diisocyanate, methylene diphenyl diisocyanate, naphthylene diisocyanates, xylylene diisocyanate, tris(4-isocyanatophenyl)methane, and polymethylenepolyphenylene diisocyanates; alicyclic polyisocyanates are methylenediphenyl diisocyanate; and tolyl diisocyanate, and aliphatic polyisocyanates are hexamethylene diisocyanate, isophorene diisocyanate, demeryl diisocyanate, 1,1-methylenebis(4-isocyanatocyclohexane-4,4′-diisocyanatodicyclohexylmethane isomer mixture, cyclohexyl 1,4-diisocyanate, (R)Desmodur grades (Bayer) and lysine diisocyanate, and mixtures thereof.

Suitable polyisocyanates are modified products obtained via reaction of polyisocyanate with polyol, urea, carbodiimide, and/or biuret.

Suitable catalysts are strong bases, alkali metal salts of carboxylic acid, or aliphatic tertiary amines. Preference is given to quaternary ammonium hydroxide, alkali metal hydroxide or alkoxide, sodium or potassium acetate, potassium octoate, sodium benzoate, 1,4-diazabicyclo[2.2.2]octane, N,N,N′,N′-tetramethylhexamethylenediamine, N,N,N′, N′-tetramethylpropylenediamine, N,N,N′,N′,N″-pentamethyl-diethylenetriamine, N,N′-di-(C₁-C₂)-alkylpiperazine, trimethylaminoethylpiperazine, N,N-dimethylcyclohexylamine, N,N-dimethylbenzylamine, N-methylmorpholine, N-ethylmorpholine, trimethylamine, triethylamine, tributylamine, triethylenediamine, bis(dimethylaminoalkyl)piperazine, N,N,N′,N′-tetramethylethylenediamine, N,N-diethylbenzylamine, bis(N,N-diethylaminoethyl)adipate, N,N,N′,N′-tetramethyl-1,3-butanediamine, N,N-diethyl-[beta]phenylethylamine, 1,2-dimethylimidazole, 2-methylimidazole etc.

It is preferable that the ratio by weight of the polyisocyanate to polyol is from 170 to 70, preferably from 130 to 80, based on 100 parts by weight of the polyol.

It is preferable that the ratio by weight of the catalyst is from 0.1 to 4 parts by weight, particularly preferably from 1 to 2 parts by weight, based on 100 parts by weight of the polyol.

Preferred blowing agents are water, hydrocarbon, fluorochlorocarbon, fluorocarbon, etc.

The amount of the blowing agent is from 0.1 to 1.8 parts by weight, preferably from 0.3 to 1.6 parts by weight, and in particular from 0.8 to 1.6 parts by weight, based on 100 parts by weight of the polyol.

Decomposition Temperatures

Prior art: salt of a symmetrically substituted phosphinic acid (aluminum bis(1-hydroxymethyl)phosphinate): 321° C.

Prior art: salt of a dialkylphosphinic acid (aluminum trisdiethylphosphinate): 340° C.

In contrast, inventive salts of asymmetrically substituted phosphinic acids: from 160 to 236° C.

The examples below illustrate the invention.

### EXAMPLE 1

140 g of demin. water and 2.6 g of aluminum hydroxide are admixed in a Berghoff laboratory autoclave with 21.9 g of an acetaldehyde-formaldehyde-adduct (comprising 64 mol % based on P content of material). The mixture is heated, with stirring, to 154° C., and this temperature is maintained for 20 h. The cooled suspension is filtered, and the resultant solid is dried at 20 mbar and 120° C. for 15 h.

### EXAMPLE 2

14 g of CaO are dispersed in 350 g of demin. water in a 1 L three-necked round-bottomed flask. Calcium hydroxide forms. 92.8 g of an acetone-formaldehyde adduct (comprising 83 mol %, based on P content of material) are also added. The mixture is heated to 90° C. and this temperature is maintained for 1 h. The cooled suspension is filtered, and the resulting solid is dried at atmospheric pressure and 120° C. for 15 h.

### EXAMPLE 3

109.2 g of an acetone-acetaldehyde adduct (comprising 77 mol %, based on P content of material) are added to 40 g of sodium hydroxide solution (50% by weight) in a 500 ml glass beaker, with stirring, at about 20° C. within a period of 10 min. The solution comprises 77 mol % (based on P) of sodium salt of acetone-acetaldehyde adduct.

### EXAMPLE 4

130.8 g of an acetone-butyraldehyde adduct (comprising 75 mol %, based on P content of material) are dissolved in 140 g of demin. water, with stirring, at about 20° C. in a 1 l glass beaker, and 62.6 g of ammonium hydroxide solution (28% by weight) are added within a period of 30 min. The solution comprises 75 mol % (based on P) of ammonium salt of acetone-butyraldehyde adduct.

### EXAMPLE 5

140 g of demin. water and 10.1 g of zinc hydroxide are admixed in a Berghoff laboratory autoclave with 85.7 g of a cyclohexanone-formaldehyde-adduct (comprising 68 mol % based on P content of material). The mixture is heated, with stirring, to 150° C., and this temperature is maintained for 5 h. The cooled suspension is filtered, and the resultant solid is dried at 20 mbar and 120° C. for 15 h.

### EXAMPLE 6

31.9 g of a benzaldehyde-formaldehyde adduct (comprising 63 mol %, based on P content of material) are dissolved in 700 g of demin. water, with stirring, in a 2 l three-necked round-bottomed flask with dropping funnel, reflux condenser, and stirrer with precision glass gland, and the mixture is heated to 50° C. In 30 min, 80 g of sodium hydroxide solution (5% by weight) are added dropwise. The resultant sodium salt is converted into the aluminum salt via addition of a further 13.7 g of aluminum sulfate solution (46% by weight of (Al₂(SO₄)3·14aq), and stirring for a further 10 min. The cooled suspension is filtered, and the resultant solid is washed with a little water and dried at atmospheric pressure and 150° C. for 48 h.

### EXAMPLE 7

166.3 g of a benzaldehyde-acetaldehyde adduct (comprising 65 mol %, based on P content of material) are dissolved in 700 g of demin. water, with stirring, in a 2 l three-necked round-bottomed flask with dropping funnel, reflux condenser, and stirrer with precision glass gland, and the mixture is heated to 90° C. Within 30 min, 20 g of sodium hydroxide are added dropwise in small portions. The resultant sodium salt is converted into the zinc salt via addition of a further 46.7 g of zinc sulfate heptahydrate, and stirring for a further 1 h. The cooled suspension is filtered, and the resultant solid is washed with a little water and dried at atmospheric pressure and 120° C. for 15 h.

### EXAMPLE 8

138.6 g of an acetophenone-formaldehyde adduct (comprising 78 mol %, based on P content of material) are dissolved in 700 g of demin. water, with stirring, in a 2 l three-necked round-bottomed flask with dropping funnel, reflux condenser, and stirrer with precision glass gland, and the mixture is heated to 90° C. Within 10 h, 40 g of sodium hydroxide solution (50%) are added dropwise. The resultant sodium salt is converted into the magnesium salt via addition of a further 48.1 g of magnesium sulfate heptahydrate, and stirring for a further 30 min. The cooled suspension is filtered, and the resultant solid is washed with a little water and dried at 50 mbar and 120° C. for 6 h.

### EXAMPLE 9

178.4 g of an acetophenone-formaldehyde adduct (comprising 78 mol %, based on P content of material) are dissolved in 700 g of isopropyl alcohol, with stirring, in a 2 l three-necked round-bottomed flask with dropping funnel, reflux condenser, and stirrer with precision glass gland. 27.7 g of titanium(IV) propoxide are then added and the mixture is heated to about 82° C. Stirring is continued for a further 10 h at this temperature. The cooled suspension is filtered, and the resultant solid is washed with a little water, and dried at atmospheric pressure and 120° C. for 15 h.

### EXAMPLE 10

140 g of demin. water and 19.8 g of magnesium hydroxide are admixed in a Berghoff laboratory autoclave with 156 g of a levulinic-acid-formaldehyde-adduct (comprising 68 mol % based on P content of material). The mixture is heated, with stirring, to 154° C., and this temperature is maintained for 10 h. The cooled suspension is filtered, and the resultant solid is dried at 20 mbar and 120° C. for 15 h.

### EXAMPLE 11

140 g of demin. water and 1.8 g of aluminum are admixed in a Berghoff laboratory autoclave with 47.3 g of a hydroxyacetone-formaldehyde-adduct (comprising 72 mol % based on P content of material). Aluminum hydroxide forms as intermediate from aluminum and water with evolution of hydrogen. The mixture is heated, with stirring, to 154° C., and this temperature is maintained for 10 h. The cooled suspension is filtered, and the resultant solid is dried at 20 mbar and 80° C. for 15 h.

TABLE 1
Amounts used and experimental conditions for Examples 1-11

| Example | Asymmetrically substituted phosphinic acid | [g] | Component A | [g] | Component B | [g] | Solvent | [g] |
|---|---|---|---|---|---|---|---|---|
| 1 | Acetaldehyde-formaldehyd adduct | 21.9 | Al(OH)3 | 2.6 | | | H2O | 140 |
| 2 | Acetone-formaldehyde adduct | 92.8 | CaO | 14.0 | | | H2O | 350 |
| 3 | Acetone-acetaldehyde adduct | 109.2 | NaOH 50% | 40.0 | | | H2O | 20 |
| 4 | Acetone-butyraldehyde adduct | 130.8 | NH4OH 28% | 62.6 | | | H2O | 140 a) |
| 5 | Cyclohexanone-formaldehyde adduct | 85.7 | Zn(OH)2 | 10.1 | | | H2O | 140 |
| 6 | Benzaldehyde-formaldehyde adduct | 31.9 | NaOH 5% | 80.0 | Al2(SO4)3*14aq | 13.7 | H2O | 700 a) |
| | | | | | (46%) | | | |
| 7 | Benzaldehyde-acetaldehyde adduct | 166.3 | NaOH 100% | 20.0 | ZnSO4+7aq | 46.7 | H2O | 700 a) |
| 8 | Acetophenone-formaldehyde adduct | 138.6 | NaOH 50% | 40.0 | MgSO4*7aq | 48.1 | H2O | 700 a) |
| 9 | Acetophenone-formaldehyde adduct | 178.4 | Ti(iPrO)4 | 27.7 | | | iPrOH | 700 |
| 10 | Levulinic acid-formaldehyde adduct | 156.0 | Mg(OH)2 | 19.8 | | | H2O | 140 |
| 11 | Hydroxyacetone-formaldehyde | 47.3 | Al | 1.8 | | | H2O | 140 |
| | adduct | | | | | | | |

a) by way of asymmetrically substituted phosphinic acid and/or reactant A

TABLE 2
Experimental conditions for Examples 1-11 (continuation of Table 1)

| | | | T | | | | | | | | |
|---|---|---|---|---|---|---|---|---|---|---|---|
| | T (rc1) | t (rc1) | (rc2) | t (rc2) | p (dr) | T (dr) | t (dr) | Yield | rml | d50 | P |
| Example | [° C.] | [h] | [° C.] | [h] | [mbar] | [° C.] | [h] | [%] | [° C.] | [μm] | [%] |
| 1 | 154 | 20.0 | — | — | 20 | 120 | 15 | 91 | 0.4 | 11 | 20.8 |
| 2 | 90 | 1.0 | — | — | 1013 | 120 | 15 | 50 | 0.1 | 70 | 17.8 |
| 3 | 20 | 0.2 | — | — | — | — | — | 100 | — | — | — |
| 4 | 20 | 0.5 | — | — | — | — | — | 100 | — | — | — |
| 5 | 150 | 5.0 | — | — | 20 | 120 | 15 | 84 | 0.1 | 15 | 13.7 |
| 6 | 50 | 0.5 | 50 | 0 | 1013 | 150 | 48 | 92 | 0.1 | 44 | 14.7 |
| 7 | 90 | 0.5 | 90 | 1 | 1013 | 120 | 15 | 88 | 0.2 | 92 | 12.5 |
| 8 | 90 | 0.5 | 90 | 10 | 50 | 120 | 6 | 89 | 0.6 | 27 | 13.6 |
| 9 | 82 | 10.0 | — | — | 1013 | 120 | 15 | 72 | 0.3 | 56 | 10.5 |
| 10 | 154 | 10.0 | — | — | 20 | 120 | 15 | 87 | 0.3 | 11 | 14.1 |
| 11 | 154 | 10.0 | — | — | 20 | 80 | 15 | 93 | 0.1 | 93 | 17.3 |

a) by way of asymmetrically substituted phosphinic acid and/or component A
rcA: reaction conditions using reactant A
rcB: reaction conditions using reactant B
dr: drying conditions
Yield: based on target product
rml: residual moisture level

1. A salt of asymmetrically substituted bis(1-hydroxymethyl)phosphinic acids, of the formula (I)
A-P(═O)(OX)—B (I)
wherein
A is R₁R₂C(OH)— and B is R₃R₄C(OH)—, with the proviso that the respective groups
R₁R₂C(OH)— and —C(OH)R₃R₄ are always different, and wherein
R₁, R₂, R₃, and R₄ are hydrogen, alkyl, alkenyl, alkynyl, aralkyl, aryl substituted aryl or a mixture thereof, and
X is an element of the first main group, an element of the second main or transition group, an element of the third main or transition group, an element of the fourth main or transition group, an element of the eighth transition group.
a nitrogen base or a combination thereof.

2. The salt of asymmetrically substituted bis(1-hydroxymethyl)phosphinic acids, as claimed in claim 1, wherein at least one of R₁, R₂, R₃, R₄ bear heteroatoms, have substitution by a functional group or both.

3. The salt of asymmetrically substituted bis(1-hydroxymethyl)phosphinic acids, as claimed in claim 2, wherein the functional group is carbonyl, aldehyde, carboxy, hydroxy, sulfonic acid, nitrile, cyano, epoxy groups; primary, secondary, or tertiary amino groups, unsubstituted, partially substituted, or fully substituted triazines or combinations thereof.

4. The salt of asymmetrically substituted bis(1-hydroxymethyl)phosphinic acids, as claimed in claim 1, wherein the alkyl groups are methyl, ethyl, n-propyl, i-propyl, n-butyl, sec-butyl, tert-butyl, n-octyl, ethylhexyl or a mixture thereof.

5. The salt of asymmetrically substituted bis(1-hydroxymethyl)phosphinic acids, as claimed in claim 1, wherein the carboxy groups are carboxyalkyl groups of (CH₂)₂CO₂H type, where n=from 1 to 6.

6. The salt of asymmetrically substituted bis(1-hydroxymethyl)phosphinic acids, as claimed in claim 1, wherein the hydroxy groups are hydroxyalkyl groups of (CH₂)ₙOH type, where n=from 1 to 6.

7. The salt of asymmetrically substituted bis(1-hydroxymethyl)phosphinic acids, as claimed in claim 1, wherein X is Li, Na, K; Mg, Ca, Zn; Al, Ce, La; Sn, Pb, Ti, Zr; Fe; NH₄, NH₃R₁, NH₂R₁R₂, NHR₁R₂R₃, or NR₁R₂R₃R₄.

8. A process for the preparation of salts of asymmetricallly substituted
bis(1-hydroxymethyl)phosphinic acids, of the formula (I), as claimed in claim 1, comprising the step of reacting an asymmetrically substituted phosphinic acid in a solvent system with a reactant A, where the reactant A is an element or a salt of an element of the first main group, an element or a salt of an element of the second main or transition group, an element or a salt of an element of the third main or transition group, an element or a salt of an element of the fourth main or transition group, an element or a salt of an element of the eighth transition group, a nitrogen base or a combination thereof.

9. A process for the production of salts of asymmetrically substituted
bis(1-hydroxymethyl)phosphinic acids, of the formula (I), as claimed in claim 1, comprising the step of converting a salt of the asymmetrically substituted bis(1-hydroxymethyl)phosphinic acid into another metal salt via addition of another reactant B.

10. A flame retardant comprising a salt of the asymmetrically substituted bis(1-hydroxymethyl)phosphinic acids, as claimed in claim 1,

11. A flame-retardant thermoplastic polymer molding composition comprising from
0.5 to 45% by weight of salts a salt of asymmetrically substituted bis(1-hydroxymethyl)phosphinic acids, as claimed in claim 1, and
from 0.5 to 99.5% by weight of thermoplastic polymer or a mixture of thermoplastic polymers,
where the entirety of the components is 100% by weight.

12. A flame-retardant thermoset polymer molding composition comprising from
0.1 to 45% by weight of salts a salt of asymmetrically substituted bis(1-hydroxy-methyl)phosphinic acids, as claimed in claim 1, from 40 to 89.9% by weight of unsaturated polyesters, from 10 to 60% by weight of vinyl monomer.

13. A flame-retardant epoxy resin, comprising from 0.5 to 50% by weight of a salt of asymmetrically substituted bis(1-hydroxymethyl)phosphinic acids, as claimed in claim 1, from 5 to 99.5% by weight of an epoxy resin, from 0 to 20% by weight of a hardener.

14. A clear lacquer, intumescent coating, wood product, cellulose-containing product, or polymer comprising the flame retardant as claimed in 10.

15. A polymer molding produced with a flame retardant as claimed in claim 10.

16. A polyester, unblended cellulose textile or blended cellusose textile impregnated with the flame retardant as claimed in claim 10.

17. A binder, cross linking agent or accelerator for epoxy resins, polyurethanes or unsaturated polyesters resins comprising a salt of asymmetrically substituted bis(1-hydroxymethyl)phosphinic acids claimed in claim 1.

18. A light stabilizer or heat stabilizer for cotton textiles, polymer fibers or plastics comprising a salt of asymmetrically substituted bis(1-hydroxymethyl)phosphinic acids as claimed in claim 1.

19. A plant-protection agent, plant-growth regulator, herbicide, pesticide or fungicide comprising a a salt of asymmetrically substituted bis(1-hydroxymethyl)phosphinic acids as claimed in claim 1.

20. A therapeutic agent or additive in a therapeutic agent comprising a salt of asymmetrically substituted bis(1-hydroxymethyl)phosphinic acids as claimed in claim 1.

21. An enzyme modulator or for stimulation of tissue growth comprising a salt of asymmetrically substituted bis(1-hydroxymethyl)phosphinic acids as claimed in claim 1.

22. A sequestering agent in petroleum production and in metal-treatment agents comprising a salt of asymmetrically substituted bis(1-hydroxymethyl)phosphinic acids as claimed in claim 1.

23. A petroleum additive comprising a salt of asymmetrically substituted bis(1-hydroxymethyl)phosphinic acids as claimed in claim 1.

24. An sequestering agent in petroleum production and in metal-treatment agents comprising a salt of asymmetrically substituted bis(1-hydroxymethyl)phosphinic acids as claimed in claim 1.

25. An antioxidant or a product for increasing octane number in a petroleum product comprising a salt of asymmetrically substituted bis(1-hydroxymethyl)phosphinic acids as claimed in claim 1.

26. A corrosion-protection agent for laundry-detergent and cleaning-product applications comprising a salt of asymmetrically substituted bis(1-hydroxymethyl)phosphinic acids as claimed in claim 1.

27. A free-radical scavenger in photosensitive layers or aldehyde scavenger in electronics applications comprising a salt of asymmetrically substituted bis(1-hydroxymethyl)phosphinic acids as claimed in claim 1.
